(19) United States
(12) Patent Application Publication
(10) Pub. No.: US 2026/0172959 A1
(43) Pub. Date: Jun. 18, 2026

(54) USER DEVICE AND BASE STATION SELECTION SUPPORT SYSTEM

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Toni Dimitrovski, Boskoop (NL); Prachi Sachdeva, Den Hoorn (NL); Antonius Hendrikus Johannes Norp, Den Haag (NL)

(21) Appl. No.: 19/129,278

(22) PCT Filed: Nov. 7, 2023
(86) PCT No.: PCT/EP2023/081013

§ 371 Date: May 12, 2025

(30) Foreign Application Priority Data
Nov. 14, 2022 (EP) 22207316.5

(51) Int. Cl. H04W 48/20; H04B 17/318

(52) U.S. Cl. CPC H04W 48/20; H04B 17/328

(57) ABSTRACT

The disclosure pertains to a user device configured to select at least one dedicated base station of a dedicated network or at least one public base station of a public network, wherein a wireless coverage area of the dedicated network overlaps at least in part with a wireless coverage area the public network. The user device comprises a receiving system configured to receive a first set of radio signal parameter values for the at least one dedicated base station and the at least one public base station. The user device also comprises a selection system configured to select the at least one public base station only when the first set of radio signal parameter values indicates location of the user device outside a dedicated service area of the dedicated network based on service area information. The user device further comprises the service area information representative of the dedicated service area of the dedicated network defined on the basis of a plurality of second sets of radio signal parameter values of the at least one dedicated base station and the at least one public base station.

### TECHNICAL FIELD

The present disclosure relates to a user device and base station selection support system. In particular, the disclosure relates to a user device configured to select at least one dedicated base station of a dedicated network or at least one public base station of a public network and wherein a wireless coverage area of the dedicated network overlaps at least in part with a wireless coverage area the public network, and to a base station selection support system for supporting such selection.

### BACKGROUND

A public wireless communication network contains a plurality of public radio base stations or cells that provide a wireless coverage area to facilitate communication of mobile devices for subscribers of the operator of the public network. An essential element of this mobility is cell (re)selection, wherein mobile devices camp on, subsequently or in addition, one or more radio base stations or cells of the public network. In some wireless communication networks, a mobile device measures a radio signal parameter value from one or more radio base stations and selects the most appropriate public radio base station from these measurements, provided that PLMN ID is acceptable to the user device. Cell reselection may be triggered when a neighbour radio base station or cell becomes better in signal strength, possibly using a set threshold, than the serving base station or cell. The use of a threshold that is to be exceeded before cell reselection is performed can be used to avoid frequent reselection between neighbouring base stations or cells when the measured radio signal parameter values of these base stations or cells are approximately equal.

Recent years have seen the development of dedicated wireless communication networks providing a wireless coverage area that may overlap with the coverage area of a public wireless communication area. Such dedicated networks are not open to everyone willing to take a subscription as for a public telecommunications network but limit access to specific user groups. Such networks include in-home networks, private networks (e.g. a factory network), or even a private part of a public network, such as a network slice of a 5G telecommunications network, etc. These dedicated networks offer wireless coverage through one or more dedicated base stations that may be connected to a public wireless communication network via a gateway device. User devices that have selected a dedicated network may reselect the public network based on the same mechanism as cell (re)selection between public base stations or cells within the public telecommunications network.

### SUMMARY

The inventors have recognized that the cell selection mechanism as applied within a public telecommunications network may be less suitable for cell selection for a user device in a dedicated network. In some instances, it is preferable for a user device in idle mode to maintain the selection of a cell of the dedicated network even when radio signal parameter values indicate that selection of a cell of the public network is favorable when radio signal strength is considered. Maintaining selection of the dedicated network may, for example, assist in establishing a service connection with the dedicated network in a quick and efficient manner.

To that end, one aspect of the present disclosure pertains to a user device configured to select at least one dedicated base station of a dedicated network or at least one public base station of a public network, wherein a wireless coverage area of the dedicated network overlaps at least in part with a wireless coverage area of the public network. The user device may comprise a receiving system and a selection system. The receiving system may be configured to receive a first set of radio signal parameter values for the at least one dedicated base station and the at least one public base station. The selection system may be configured to select the at least one public base station only when the first set of radio signal parameter values indicates location of the user device is outside a dedicated service area of the dedicated network based on service area information. The user device may comprise the service area information representative of the dedicated service area of the dedicated network defined on the basis of a plurality of second sets of radio signal parameter values of the at least one dedicated base station and the at least one public base station.

Another aspect of the disclosure involves a base station selection support system configured to support selection of at least one dedicated base station of a dedicated network or at least one public base station of a public network, wherein a wireless coverage area of the dedicated network overlaps at least in part with a wireless coverage area of the public network. The base station selection support system contains service area information representative of the dedicated service area of the dedicated network defined on the basis of a plurality of second sets of radio signal parameter values of the at least one dedicated base station and the at least one public base station. The base station selection support system may further comprise a transmission system for transmitting the service area information to a user device for selection of a dedicated base station on the basis of the transmitted service area information.

The disclosed user device and base station selection support system allow to control cell (re)selection in idle mode by estimating location of the user device to be within or outside of a dedicated service area defined on the basis of radio signal parameter values that may be used as a kind of coarse coordinate system for cell selection purposes. The service area information may be provided from the base station selection support system to support cell selection in the idle mode user device. In an alternative, the user device may derive the service area information from the second sets itself. When the user device estimates that its location is within the dedicated service area, selection of a cell of the dedicated network may be maintained even when the radio signal parameter values of the public network for the user device indicate that selection of a cell of the public network would be preferred based on signal strength. Cell selection of a cell of the public network may be performed by the user device when the location of the user device is estimated to be outside (or logically equivalent, estimated to be not inside) of the dedicated service area.

However, when the user device approaches the dedicated network while a cell of the public network is selected, cell selection of a cell of the dedicated network may be conducted by the user device based on the best signal strength according to the prior art described in the background. Hence, the user device may conduct asymmetric cell selection, i.e. control cell selection of a cell of the dedicated network when camping on a cell of the public network different from selection of a cell of the public network when camping on a cell of the dedicated network.

On the other hand, particularly when the user device has already received the service area information, the user device may select the dedicated network when the user device determines that its location is now inside the dedicated network area whereas it was outside the dedicated network at an earlier stage. In this embodiment, the user device handles cell selection in a symmetric manner, i.e. cell selection is controlled similarly when moving in and out of the dedicated network based on the service area information.

It should be appreciated that the service area information may be stored in a storage system or memory system of the user device and/or the base station selection support system.

It should also be appreciated that the user device and/or base station selection support system allow to define the dedicated service area in an arbitrary manner. One example is to define the dedicated service area within boundaries formed by the walls of a house or other indoor building or along the perimeter of an area containing the house or building, e.g. a garden or factory area. However, more complicated dedicated service areas can be envisaged, such as areas within a building, for example some particular rooms of a building wherein continued selection of the dedicated network is particularly preferred, or an outdoor area, for example a private area such as a harbor, airport or zoo.

It should be appreciated that the dedicated service area may coincide with the area covered by the one or more base stations of the dedicated network or may be a subarea of the area covered by the one or more base stations of the dedicated network.

It should be appreciated that the dedicated service area for cell selection may coincide with a dedicated service area for handover decisions. To that end, a handover management system and user device are disclosed in the co-pending patent application EP22196648.4 which is incorporated in the present disclosure in its entirety. Also, it should be appreciated that functionality of both applications may be the same and/or may be combined, for example where the same terms are used, or combining the handover management system and the base station selection support system in a single system. There may be additional efficiency in combining (parts of) the co-pending application and this application, for example service area information may be obtained in a single procedure for both handover management and cell re-selection.

It should also be appreciated that both the public network and dedicated network may comprise 3GPP 5G networks. However, the radio access technology of the dedicated network applied by the at least one dedicated base station may also differ from the access technology of the public base station. For example, the dedicated base stations of the dedicated network may comprise wireless access points, such as WiFi access points.

Finally, it should be appreciated that the radio signal parameter values may comprise values that are measured from radio signals received from public and/or dedicated base stations. The first set of radio signal parameter values may comprise a set of dynamically changing parameter values of the radio signals that are momentarily measured during normal operation of a user device (or averages of a few measurements). The second sets of radio signal parameter values may comprise a more sizeable number of measurements that may be relatively static, compared to the first set, to define the dedicated service area.

In one embodiment, the radio signal parameter values of the first and second sets comprise reference signal received power, RSRP, measurements. RSRP measurements (typically expressed in dBm) are frequently used in telecommunications for cell selection decisions and provide for a relatively simple implementation for the user device and base station selection support system. It should be appreciated that other parameters may be used as an alternative or in addition, such as reference signal received quality, RSRQ, and/or reference signal signal-to-interference (RS-SINR), typically expressed in dB, to determine location of the user device, although some additional processing of these parameter values may be required.

In one embodiment, the user device is configured to obtain the plurality of second sets of radio signal parameter values of the at least one dedicated base station and the at least one public base station to derive the service area information in the user device. This embodiment enables the user device to derive the service area information for itself, so that the disclosed cell selection can be performed entirely in the user device. The embodiment allows the user of the user device to define the dedicated service area, for example by traversing the area wherein selection of a dedicated base station cell is to be maintained. The embodiment allows the user device to be in idle mode during the service area definition mode. In one example, the user device may know which base stations are dedicated base stations.

In one embodiment, the user device is configured to transmit the second sets of radio signal parameter values of the at least one dedicated base station and the at least one public base station to a base station selection support system of the dedicated network. In this case, the user device is at least temporarily in connected mode during the service area definition mode. In this case, the user device has established a, possibly temporary, connection or has initiated a connection (e.g. an RRC Connection Establishment message) or terminated a connection (e.g. an RRC Connection Release message) to the base station selection support system over, for example, the dedicated network. The embodiment enables a base station selection support system to derive the service area information centrally. One advantage of such central derivation is that other user devices may be provided with this service area information to enable cell selection without needing to gather the second sets of radio signal parameters themselves. Another advantage is that the derivation process or computation may need energy and or processing power which a user device may have only a limited supply of.

In one embodiment, the user device is configured to receive the service area information from a base station selection support system of the dedicated network. In this case, the user device is at least temporarily in connected mode, for example but not necessarily during the service area definition mode. In this case, the user device has established a connection or has initiated a connection (e.g. an RRC Connection Establishment message) or terminated a connection (e.g. an RRC Connection Release message) to the base station selection support system over, for example, the dedicated network. The embodiment enables a user device to perform the cell selection without the need to derive service area information and receive it from the base station. It may also enable the user device to perform the cell selection without the need to obtain or measure the second sets of radio signal parameter values, in case another user device has done so.

In one embodiment, the user device is configured to use service area information that may comprise a machine learning model. The model is trained using at least second sets of radio signal parameter values. This training may be performed either in the user device or in a base station selection support system. The first set of radio signal parameter values is input to the trained machine learning model and the output indicates whether the user device is located outside the dedicated service area. The machine learning model may be applied to obtain more accurate estimations of the location of the user device vis-á-vis the dedicated service area. Application of the model may, for example, be useful when higher accuracy is required or for more complicated dedicated service areas. In one further embodiment, the output of the machine learning model is a binary output indicating location of the user device inside or outside of the dedicated service area and the model is trained in addition using at least third sets of radio signal parameter values of the at least one dedicated base station and the at least one public base station outside of the dedicated service area. It should be appreciated that for gathering the third sets of radio signal parameter values, the user device may be set to a different mode than the service area definition mode for registering the dedicated service area.

Similarly, if the service area information is in the base station selection support system, the base station selection support system may comprise such a machine learning model to provide to the user device.

In one embodiment, the user device is configured to use service area information that comprises a representation of second sets of radio signal parameter values enabling evaluation of the first set of radio signal parameter values to estimate whether the user device is located outside the dedicated service area. In this embodiment, the second sets of radio signal parameters may be processed with one or more mathematical operations to obtain the service area information. The service area information may, for example, comprise values, boundary values, intervals, or any other representation of the second sets of radio signal parameter values suitable to define the dedicated service area and to estimate location of the user device vis-á-vis the dedicated service area. In one embodiment, the evaluation may comprise a comparison of the first set of radio signal parameter values with a representation of the second sets of radio signal parameter values to estimate whether the first user device is located outside the dedicated service area.

Similarly, if the service area information is in the base station selection support system, the base station selection support system may comprise such a representation to provide to the user device.

In one embodiment, the user device may be configured to be set to a service area definition mode in response to a service area definition mode instruction from a base station selection support system. This embodiment enables control from the base station selection support system to set one or more user devices to service area definition mode. In service area definition mode, the user device is set to acquire the second sets of radio signal parameter values for defining the dedicated service area and, optionally, report these to the base station selection support system. During this operation, the user device may gather several second sets of radio signal parameter values, such as RSRP values, each set comprising values from both one or more dedicated base stations and from one or more public base stations. It should also be appreciated that the base station selection support system may also be configured to terminate the service area definition mode for itself and/or in the user device.

It should be appreciated that the user device in service area definition mode may be a device that also performs cell selection after defining the dedicated service area, such as the user device mentioned above, or a special purpose device for defining the dedicated service area.

In one embodiment, the service area definition mode instruction provides a report time interval for the user device to report the second sets of radio signal parameter values. It is noted that the report time intervals may vary from case to case or from device to device. A high frequency of reports may be required for an appropriate, for example more accurate, service area definition.

Similarly, one embodiment pertains to a base station selection support system that may be configured to acquire the second sets of radio signal parameter values for defining the dedicated service area from a user device as described above or from another user device. Optionally, the base station selection support system may be configured to send a service area definition mode instruction to at least one of the user device and the other user device to acquire the second sets of radio signal parameter values for defining the dedicated service area. Optionally, the service area definition mode instruction provides a report time interval for the user device or the other user device to report the second sets of radio signal parameter values.

In one embodiment, the user device may be configured to be set to a service area definition mode in response to a user input on the user device. The embodiment enables independent setting of the service area definition mode by the user.

In one embodiment, the user device is configured to transmit at least one identifier of at least one dedicated base station, such as a closed access group identifier, CAG ID, or a group of cell IDs, to a base station selection support system, for example in service area definition mode. The identifier may assist in controlling access to the dedicated network and may assist the base station selection support system to derive the service area information also when base stations within signal reach should not be included in the service area definition, e.g. base stations belonging to a different nearby owner.

In one embodiment, the user device is configured to receive and process at least one identifier of at least one dedicated base station to determine dedicated base stations during service area definition mode for which radio signal parameter values for the second sets are measured. Such an identifier or identifiers may be contained in a service area definition mode instruction received from a dedicated base station. The identifier or identifiers may serve to inform the user device for which dedicated base station(s) radio signal parameter values should be gathered for the second sets. Optionally, the identifier may be contained in a service area definition mode instruction. Having an identifier or identifiers of one or more dedicated base stations enables informing the user device from, for example, a base station selection support system, for which dedicated base stations second sets should be acquired by the user device.

In one embodiment, the user device may be configured to receive the service area information via at least one signaling message. Optionally, the signaling message is at least one of a radio resource control, RRC, message for connection establishment, an RRC message for connection release, a Non-Access Stratum, NAS, message for connection establishment, a NAS message for connection release and a policy message from a Policy Control function. The RRC signaling message may be used for including the information at a base station, the NAS message for including the information in the core network (e.g. in an Access Management Function, AMF, of a 5G core network), and the policy message for including the information at a policy control function, PCF, in a 5G core network.

Similarly, in one embodiment, the base station selection support system is configured to transmit the service area information to the user device using at least one signaling message. Optionally, the signaling message is at least one of a radio resource control, RRC, message for connection establishment, an RRC message for connection release, a Non-Access Stratum, NAS, message for connection establishment, a NAS message for connection release and a policy message from a Policy Control function. The RRC signaling message may be used for including the information at a base station, the NAS message for including the information in the core network (e.g. in an Access Management Function, AMF, of a 5G core network), and the policy message for including the information at a policy control function, PCF, in a 5G core network.

Dedicated networks with a large service area and dedicated networks having higher frequency base stations may have deployed a plurality of dedicated base stations. In one embodiment, the dedicated network comprises at least a first dedicated base station and a second dedicated base station. The base station selection support system, which may be located within a dedicated base station, may be configured to initiate handover of the first user device from the first dedicated base station to the second dedicated base station based on receiving a first radio signal parameter value for the first dedicated base station and a second radio signal parameter value for the second dedicated base station and comparing these values. The embodiment allows handover between dedicated base stations to be performed according to conventional handover mechanisms, so that user devices communicating within the dedicated network may be served by the base station with the best radio connection for communication of the second sets of radio signal parameter values towards or from the user device or for communication of the service area information. A threshold may be applied to avoid frequent handover between dedicated base stations when a user device measures approximately equal radio signal parameter values.

Likewise, in one embodiment, the user device may be configured to receive a first radio signal parameter value for a first dedicated base station and a second radio signal parameter value for a second dedicated base station to perform cell selection in the dedicated network based on comparing these values. Applying conventional cell reselection within the dedicated network (based e.g. on CAG ID or cell ID) is beneficial for an idle mode user device when it desires to connect to the dedicated network to report the second sets of radio signal parameter values to the base station selection support system.

The base station selection support system may be set to the service area definition mode in various ways.

In one embodiment, at least a part of the base station selection support system is configured to be set to a service area definition mode to acquire the second sets of radio signal parameter values by receiving a service area definition mode instruction from a user device. This embodiment allows the user of the user device to set the base station selection support system in service area definition mode. This embodiment, for example, facilitates the base station selection support system to provide second sets of radio signal parameters and/or the service area information to the user device or another user device.

In one embodiment, the base station selection support system is configured to communicate setting the service area definition mode from a first dedicated base station to a second dedicated base station. Such communication may be conducted over direct connections between the dedicated base stations or via the public network. The embodiment facilitates service area definition mode behavior for all dedicated base stations of the dedicated network. Such service area definition mode behavior comprises collecting and/or processing second sets of radio signal parameter values to define the dedicated service area, for example by training a machine learning model or to obtain a representation of such a dedicated service area. The user devices may be in connected mode to provide second sets to the different dedicated base stations during service area definition or in idle mode during service area definition and transmit the second sets afterwards to (an arbitrary one) of the informed dedicated base stations. The service area information may be transmitted to the user device to perform cell selection, for example from one of the informed dedicated base stations.

The base station selection support system comprising at least a first dedicated base station and a second dedicated base station, and/or the user device, may store, use or distribute the second sets of radio signal parameter values in various ways. The base station selection support system may be configured to send at least one of the second sets of radio signal parameters and the service area information to the user device afterwards.

In one embodiment, the first dedicated base station and the second dedicated base station may be configured to store the second sets of radio signal parameter values received from the user device or another user device at least during service area definition mode. Since a user device may report the second sets of radio signal parameter values to any one of the dedicated base stations, both the first dedicated base station and the second dedicated base station may receive second sets of radio signal parameter values. To define the dedicated service area, it is advantageous that the dedicated base stations of the dedicated network store these values to allow defining the dedicated service area when the user device has finished measurements.

In one embodiment, the first dedicated base station and the second dedicated base station may exchange second sets of radio signal parameter values with each other. The embodiment enables each dedicated base station to obtain all the second sets of radio signal parameter values for the dedicated base stations of the dedicated network, so that each individual base station can obtain the service area information for the entire service area. Accordingly, each base station may provide the service area information to a user device.

In one embodiment, the first dedicated base station and the second dedicated base station may send the second sets of radio signal parameter values to a central location or to the first user device or other user device. This facilitates centralization of the service area information for a centralized base station selection support system or enables distribution of the second sets of radio signal parameter values by the user device. It also facilitates the user device to be able to use the second sets of radio signal parameter values to derive the service area information.

In one embodiment, the first dedicated base station may obtain service area information representative of a dedicated service area of the first dedicated base station of the dedicated network on the basis of the received second sets of radio signal parameter values and the second base station obtaining service area information representative of a dedicated service area of the second dedicated base station of the dedicated network on the basis of the received second sets of radio signal parameter values. This embodiment facilitates that each dedicated base station provides the user device with service area information for the part of the dedicated network during which the base station was connected to the user device.

The base station selection support system and/or the user device may terminate the service area definition mode in various ways. Termination of the service area definition mode enables activating the user device to perform cell selection based on the service area information by estimating the location of the user device.

In one embodiment, the base station selection support system is configured to receive a service area definition mode termination instruction from a user device. The embodiment facilitates user control to switch the base station selection support system back to normal operation.

In one embodiment, the base station selection support system is configured to terminate the service area definition mode. The base station selection support system may, for example, monitor expiry of a definition mode timer and/or analyze the second sets of radio signal parameter values to decide on termination of the service area definition mode.

For dedicated networks comprising more than one dedicated base station, one embodiment pertains to the base station selection support system being configured to communicate the termination of the service area definition mode from a dedicated base station to one or more other dedicated base stations of the dedicated network. This embodiment may be advantageous when the dedicated base stations in the dedicated network are aware of each other's existence and are communicatively connected to each other.

One other embodiment involves the base station selection support system configured to store information from which dedicated base station a user device entered a cell of a dedicated base station in service area definition mode and forwarding a service area definition mode termination indication in accordance with the stored information. The embodiment enables forwarding the service area definition mode termination indication back along and in the order of the dedicated base stations to which the user device connected in service area definition mode, when the user device sends the service area definition termination instruction to the dedicated base station to which it is connected upon termination. This is advantageous for a dedicated network wherein the dedicated base stations are not aware of each other's existence in the network and, for example, the user device was in connected mode during measuring

In one embodiment, the base station selection support system is part of at least one dedicated base station.

Another aspect of the present disclosure involves a method in a user device. The user device is configured to select at least one dedicated base station of a dedicated network or at least one public base station of a public network, wherein a wireless coverage area of the dedicated network overlaps at least in part with a wireless coverage area the public network. The method involves the step of receiving a first set of radio signal parameter values for the at least one dedicated base station and the at least one public base station and may involve a step of selecting the at least one public base station only when the first set of radio signal parameter values indicates location of the user device outside a dedicated service area of the dedicated network based on service area information, The user device may comprise the service area information representative of the dedicated service area of the dedicated network defined on the basis of a plurality of second sets of radio signal parameter values of the at least one dedicated base station and the at least one public base station.

Still another aspect of the present disclosure pertains to a method in a base station selection support system configured to support selection of at least one dedicated base station of a dedicated network or at least one public base station of a public network, wherein a wireless coverage area of the dedicated network overlaps at least in part with a wireless coverage area of the public network. The method involves the step of obtaining service area information representative of the dedicated service area of the dedicated network defined on the basis of a plurality of second sets of radio signal parameter values of the at least one dedicated base station and the at least one public base station. The method may, preferably, also comprise the step of transmitting the service area information to a user device for selection of a dedicated base station on the basis of the transmitted service area information.

Yet another aspect of the disclosure comprises a computer program comprising software code portions configured for, when executed by a computer system, cause the computer system to perform the method as defined above for the user device or the base station support system.

Also, an aspect of the disclosure relates to a telecommunications system comprising a base station selection support system and a user device as defined in the present disclosure.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the person's computer, partly on the person's computer, as a stand-alone software package, partly on the person's computer and partly on a remote computer, or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 is a schematic illustration of a few public base stations of a public telecommunications network providing cells overlapping dedicated telecommunications networks having at least one dedicated base station;

FIG. 2 is a detail of FIG. 1 illustrating inefficient traffic flow when a user device is connected to a public base station while consuming a service from the dedicated network;

FIG. 3 is a schematic illustration of an embodiment of a base station selection support system for enabling a user device to select a dedicated base station of a dedicated network to camp on in idle mode;

FIG. 4 is a signaling flow chart showing some steps for the base station selection support system and user device for use with the base station selection support system;

FIG. 5 is a schematic illustration of an embodiment of a user device for use with a base station selection support system;

FIGS. 6A and 6B are schematic illustrations of a practical example of operation of the base station selection support system and user device;

FIG. 7 is a schematic illustration of an embodiment of a base station selection support system and user device for use with the base station selection support system for a dedicated network having a plurality of dedicated base stations; and

FIG. 8 depicts a processing system according to an embodiment for a base station selection support system or user device for use with the base station selection support system.

### DETAILED DESCRIPTION OF THE DRAWINGS

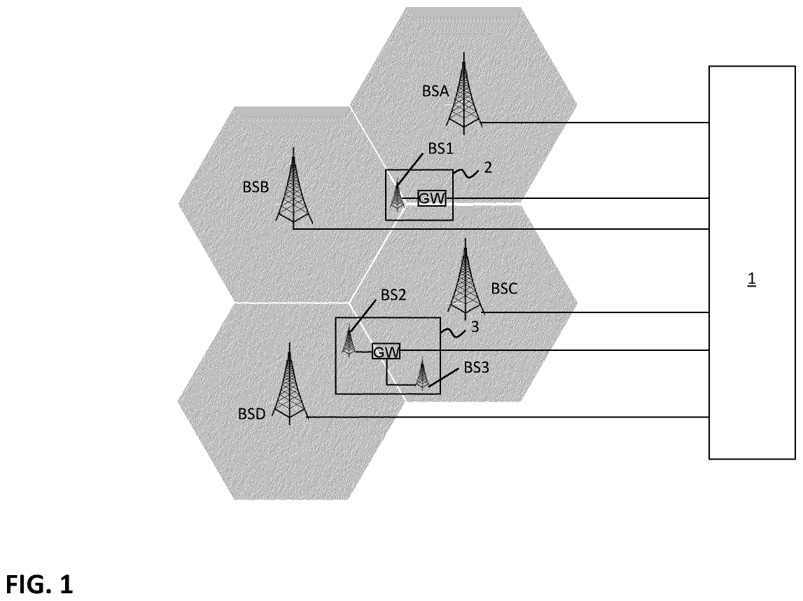

FIG. 1 is a schematic illustration of a public telecommunications network showing a few public base stations BSA-BSD connected to a core network system 1. The base stations BSA to BSD define a plurality of cells for a wireless coverage area. The terms base station and cell will be used interchangeably in the present disclosure.

In one example, the public telecommunications network is a 5G telecommunications network as defined by 3GPP. The 5G telecommunications network is composed of a 5G access network and a 5G core network (5GC) 1. The access network is made up of a new-generation radio access network (NG-RAN) which uses the 5G new radio interface (NR). The NG-RAN comprises 5G base stations such as BSA to BSD, also referred to as gNB's, which are connected to the 5GC 1 and, optionally, to each other. The 5GC 1 comprises various systems for performing network signaling functions, such as the Access and Mobility Function, AMF, the Session Management Function, SMF and the Policy Control Function, PCF, known as such to the skilled person. The higher frequencies of 5G networks reduces the range of the 5G base stations BSA-BSD. In order to provide continuous coverage, the public base stations BSA-BSDs are placed closer together and thus the density of public base stations increases when compared to previous generation networks. As a result, more cells of adjacent public base stations overlap, and users will be more likely to be under coverage from multiple public base stations (from other cells).

Dedicated networks are deployed within the coverage area of base stations BSA to BSD. The dedicated networks comprise base stations BS1, BS2 and BS3 and are connected via a gateway GW to the public telecommunications network in a wired or wireless fashion. The wireless coverage areas of the base stations BS1-BS3 of the dedicated networks overlap with the wireless coverage area of the public base stations BSA-BSD and may span a particular area 2, 3, such as a house, office or factory site. Such base stations BS1-BS3 may also be constituted by wireless access points applying a radio access technology different from public radio base stations BSA-BSD.

Dedicated networks include in-home networks, private networks (e.g. a factory network), or even a private part of a public network, such as a network slice of a 5G telecommunications network, etc. These dedicated networks offer wireless coverage through one or more dedicated base stations BS1-BS3 that may be connected to a public wireless communication network via a gateway device GW. User devices in connected mode connected to a dedicated network may be handed over to the public network based on the same mechanism as handover between public base stations or cells within the public telecommunications network. In idle mode, user devices may select a cell of either the public network or the dedicated network dependent on the location and signal strength.

One example of a dedicated network is a private network, such as a home network, office network or factory network. For example, with the rise of home automation and Personal IoT, more and more traditional non-networked home devices can become networked and be used and managed via remote monitoring, e.g. with a mobile app in a user device UE. In addition to the existing applications (e.g. printers, computers, smartphones), home networks may also be used for other home elements, such as entertainment (e.g. smart television, audio and game consoles), lighting, security and climate systems (i.e. environmental conditioning). These local devices may be connected via a (converged) home network and be provided as local services via a local user plane function, UPF, residing in the home. The user may use these home services through the converged home network, while also having access to the public network (i.e. internet), by being connected to the home UPF via a local base station BS1, BS2, BS3 (also referred to as home gNB or Premises Radio Access System, PRAS). This may lead to lower user costs, higher performance and more privacy protection as the home services are used within the (local) home network.

The dedicated base stations BS1-BS3 may provide 5G small cells, which are easily deployed and may help to fill coverage gaps between large 5G base stations BSA-BSD of the public telecommunications network supplementing the coverage of macro sites. These dedicated networks may have a smaller coverage area depending on signal strength and aim to only provide in-home connectivity. However, since radio signals attenuate through different surfaces, they may not follow a particular geographical shape.

In connected mode, mobile user devices may be handed over from a base station BS1, BS2, BS3 of the dedicated network to a base station BSA-BSD of the public network based on received signal strength at a particular moment in time. This signal strength is generally measured on a pilot signal or reference signal emitted from the various base stations. Handover may occur more easily when the user device is around the border of the house area 2, i.e. in the garden or in the attic of the house if far from the dedicated base station BS1, BS2 or BS3. Similarly, in idle mode, mobile user devices are more likely to select a public base station BSA-BSD when moving further away from the dedicated base stations BS1, BS2, BS3, despite still being located in the house or private area.

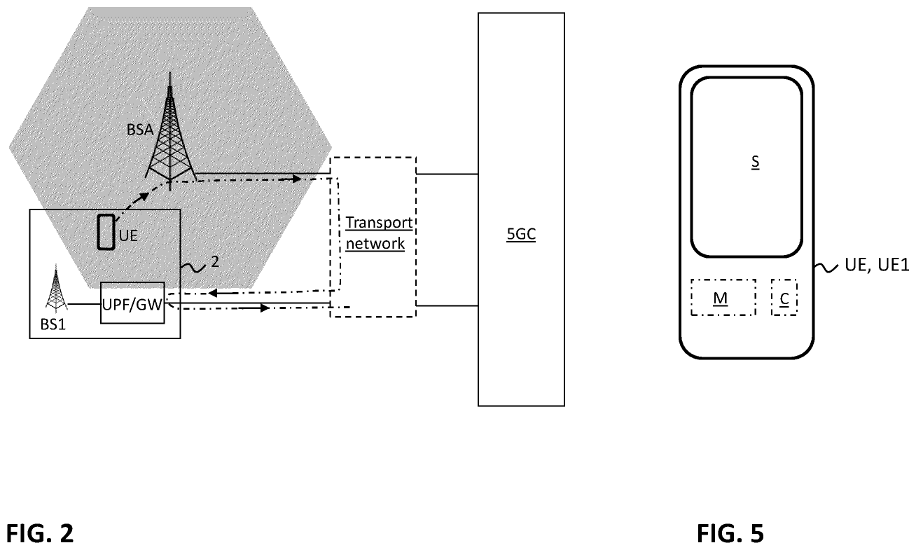

When a user device UE is in the home at the border of the area as shown in FIG. 2, a user device UE in idle mode may select a public base station BSA to camp on because of signal strength being better for public base station BSA than for dedicated base station BS1. While camping on the public network in idle state, when switching to connected mode to use a local service, the user device UE will be connected via public base station BSA and a UPF/GW to a core network of a network operator. This is not efficient, because the UE is still in the house area 2 and desires to use a local service, but the UE is now connected to the public base station BSA and the public base station BSA routes the user plane traffic through a transport network of an operator, only to go back towards the home UPF. Even though the UE may be geographically in the wireless coverage area of the home network, the connection to the base station BSA causes the data to go through the longer path of the public network as shown by the dash-dotted line, instead of using BS1. For the UE traffic is transported twice instead of once, as it goes through operator backhaul because the user plane is first carried from the public base station BSA to the home UPF (first transport), and then from the home UPF to the public UPF (second transport) in the 5GC. If the local service would be handled solely in the local network, the trajectory from the home UPF to the public UPF (second transport) in the 5GC would not be necessary. Furthermore, traffic is less private than necessary, and performance could be impacted, due to e.g. delay time.

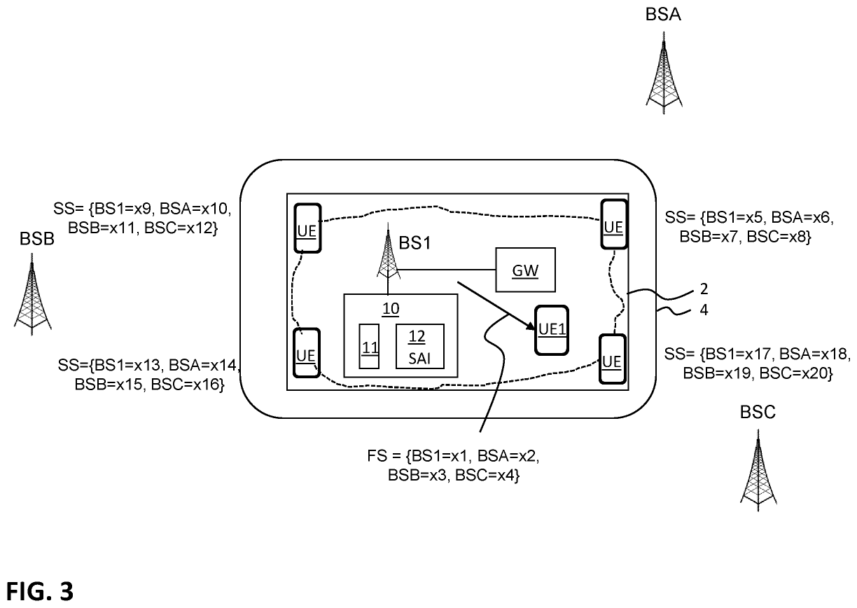

FIG. 3 is an embodiment of a base station selection support system 10 that allows a user device UE1 to select a base station BS1 of the dedicated network to camp on in idle state. However, when user device UE1 actually leaves the area 2 (for example, the user device UE1 leaves the house), it is useful for UE1 to select a base station of the public network to enable connection with the public network when necessary. Furthermore, when user device UE1 re-enters the home area 2 or is close to that area such that the dedicated network may provide a suitable connection, UE1 may, in one embodiment, select a base station of the dedicated network based on the common radio signal parameter value comparison. The base station selection support system 10 according to the present disclosure may therefore be especially suitable to support a decision for UE1 on whether to maintain selection of a base station BS1 of the dedicated network when moving to the border of the area and such decision is based on the estimation that UE1 is located within the service area as described in further detail below. However, cell selection of a base station BS1 of the dedicated network by UE1 previously having selected a public base station BSA-BSC of the public network may, in another embodiment, also be based on the estimation that UE1 is located within the service area as described in further detail below.

In idle mode, the user device UE1 receives a first set FS={x1, x2, x3, x4} of radio signal parameter values for the at least one dedicated base station BS1 and the public base stations BSA-BSC of the public telecommunications network for which these values are measured. In particular, the user device UE may measure radio signal parameter value x1 from dedicated base station BS1, x2 from public base station BSA, x3 from public base station BSB and x4 from public base station BSC. In the prior art, the user device UE1 bases cell reselection on these values.

However, as will be described below in further detail, the present disclosure presents an alternative way to perform cell (re)selection by the user device UE1, viz. by using service area information SAI.

An embodiment for acquiring and using the service area information SAI will now be described with reference to FIGS. 3-5.

A user device UE, which may or may not be user device UE1 described above, may be set in service area definition mode. In the service area definition mode, the user device UE may be in connected mode or in idle mode for at least some time. When the user device UE collects the measurements of the radio signal parameter values in service area definition mode in idle mode, it may switch to connected mode to, for example, transfer one or more second sets SS of radio signal parameter values to the base station selection system 10.

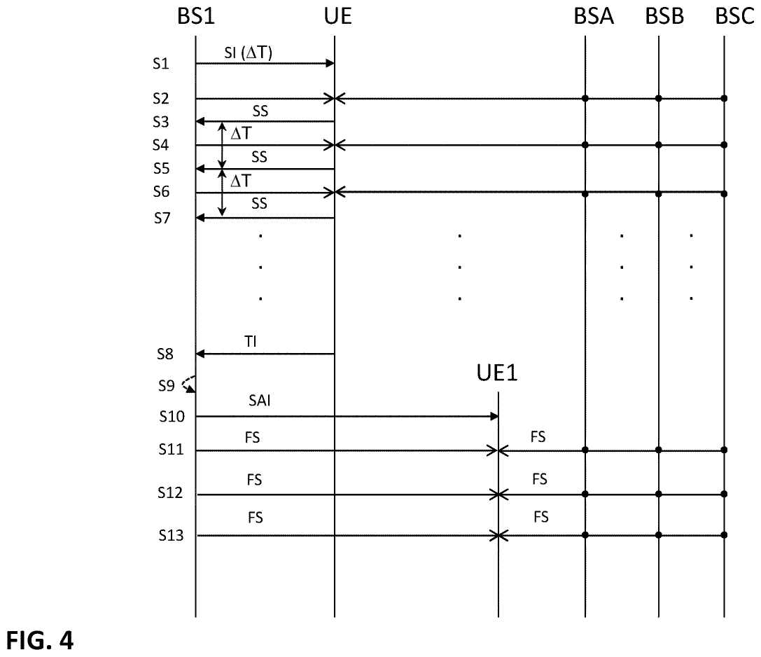

In one embodiment, the base station selection support system 10 is configured to send a service area definition mode start instruction SI to the user device UE in step S1 of FIG. 4. This embodiment enables control from the base station selection support system 10 to set the user device UE to service area definition mode to report second sets SS of radio signal parameter values to the base station selection support system 10.

In service area definition mode, the user device UE measures radio signal parameter values while moving, for example approximately along the desired perimeter of the dedicated service area as shown by the dashed line in FIG. 3. The radio signal parameter value measurements are shown by steps S2, S4, S6 in FIG. 4. For example, at the start location in the top right corner, the user device UE may measure radio signal parameter value x5 from dedicated base station BS1, x6 from public base station BSA, x7 from public base station BSB and x8 from public base station BSC to form a second set SS. Some further second sets SS are also shown in FIG. 3. It should be appreciated that (many) more second sets may be acquired by the user device UE. The UE may be in connected mode or idle mode during performing the measurements.

The service area definition mode instruction SI in step S1 may include a report time interval AT for the user device UE to report the second sets SS of radio signal parameter values. The report time interval AT may be different from regular report time intervals for handover to obtain an appropriate definition of the dedicated service area 2.

As another example, a user may set user device UE in service area definition mode through interaction with the user device UE, while the user device is in idle or connected mode. To that end, the user device UE may be configured with program code C to enable the service area definition mode by showing a menu on the screen S as shown in FIG. 5. User device UE may be configured to store in memory M one or more second sets SS with measured radio signal parameters x.

If the report time interval AT is implemented, measurements of radio signal parameter values are reported at this time interval as shown. In steps S3, S5 and S7, the UE in connected mode reports the second sets of values SS for the various locations of the user device to the serving dedicated base station BS1. It should be noted that it is not necessary to report individual second sets SS of values to the serving base station as shown in FIG. 4. The user device UE may store second sets SS (or values allowing construction of the second set SS) of radio signal parameter values in memory M of the user device (FIG. 5), when in idle or connected mode.

For an active user device UE in service area definition mode, the base station selection support system 10 comprising serving base station BS1 is configured to disable handover for the UE during this service area definition mode. Hence, when definition of the service area is in progress, the base station selection support system 10 does not command the active user device UE collecting the second sets SS of radio signal parameter values to connect to a public base station BSA-BSC but to maintain connection to the dedicated base station BS1 so that the base station selection support system 10 may collect the second sets SS and report these via the dedicated base station BS1.

When the user device UE is in idle mode during conducting the measurement for the service area definition, the user device UE may be configured to maintain selection of the dedicated base station BS1 in order to enable a connection with the dedicated base station if the measurements are to be reported to the base station selection support system 10.

Measurements (and reporting of the associated second sets SS of radio signal parameter values in connected mode of the user device UE) may be repeated as long as service area definition mode is in operation.

When service area definition mode is finished, the user device UE may indicate this to the serving dedicated base station BS1 in a service area definition mode termination indication TI in step S8. Step S8 may be triggered by the user of the user device UE operating a menu item on screen S of user device UE for transmitting a service area definition mode termination instruction TI.

Other implementations for terminating the service area definition mode are envisaged, such as terminating the service area definition mode from the network or in the user device UE based on one or more of expiry of a timer and on an analysis of the second sets of parameters. For example, when radio signal parameter values of the second sets stay within a particular value range for a certain period of time, the base station selection support system 10 or user device UE may decide to terminate the service area definition mode or to send a request to the user device UE to end the service area definition mode.

The base station selection support system 10 may also comprise or be connected to a storage system or memory system 12 storing service area information SAI representative of a dedicated service area 2 of the dedicated network defined on the basis of a plurality of second sets SS of radio signal parameter values of the at least one dedicated base station BS1 and the public base stations BSA-BSC at different locations throughout the service area 2. In step S9, as an option, the base station selection support system 10 processes the received second sets SS of radio signal parameter values to obtain the service area information SAI to estimate location of a user device UE or UE1 for controlling cell (re)selection. Alternatively, the base station selection support system 10 may store the received second sets SS of radio signal parameter values in raw form or in processed form.

In step S10, the base station selection support system 10 transmits the received second sets SS or the service area information SAI to a user device UE or UE1 (as shown in FIG. 4). This information enables the user device UE1 to select a cell of the dedicated network when evaluating the first set FS of radio signal parameter values against the service area information SAI. The user device UE1 may be configured to receive the service area information SAI in step S10 via at least one signaling message. To receive this signaling message, the user device UE1, when in idle mode, switches temporarily to connected mode. The signaling message may at least comprise one of a radio resource control, RRC, message for connection establishment, an RRC message for connection release, a Non-Access Stratum, NAS, message for connection establishment, a NAS message for connection release and a policy message from a Policy Control function or other RRC or NAS message. The RRC signaling message may be used for including the information at a base station, the NAS message for including the information in the core network (e.g. in an Access Management Function, AMF, of a 5G core network), and the policy message for including the information at a policy control function, PCF, in the 5G core network.

Alternatively, in case the UE is in idle mode during service area definition mode, steps S3, S5 and S7 can be omitted and the second sets SS can be stored in UE memory. In one embodiment, the UE may send the second sets SS to the base station selection support system at a later point in time. In another embodiment, the user device UE may use the second sets SS for its own benefit, i.e. to obtain the service area information to perform cell (re)selection.

The base station selection support system 10 may be configured to obtain service area information that may comprise a machine learning model and transmit this model to the user device UE1 in step S10. The model may be trained using at least the second sets SS of radio signal parameter values obtained from user device UE. In this manner, the model may be used by the user device UE1 to estimate when it is outside the dedicated service area by inputting the first set FS of radio signal parameter values in the trained machine learning model and the output indicates whether the first user device UE is located outside the dedicated service area 2. The machine learning model may be applied to obtain more accurate estimations of the location of the user device UE1 vis-á-vis the dedicated service area 2. Application of the model may, for example, be useful when higher accuracy is required or for more complicated dedicated service areas. Alternatively, the user device UE1 may be configured to obtain the service area information itself in the same manner.

The output of the machine learning model is a binary output indicating location of the first user device inside or outside of the dedicated service area 2. For example, the user may use user device UE and walk around the building 2 through the garden 4 to measure radio signal parameter values for a third set of values representative of location outside the dedicated service area. In this mode, the user device UE may be camping on one or more public base stations and store the third sets of radio signal parameter values for BS1 and BSA-BSC in memory M and report these third sets to the base station selection support system at a later point in time when connected to base station BS1. Alternatively, the user device UE may remain camped on the dedicated base station BS1 but having a bad signal since connectivity is not required in idle mode, in which case temporally storing the third sets of parameter value in the user device UE would be beneficial.

The model may be trained in addition using at least the third sets of radio signal parameter values of the at least one dedicated base station BS1 and the public base stations BSA-BSC outside of the dedicated service area. It should be appreciated that for gathering the third sets of radio signal parameter values, the first user device or other user device may assume a different service area definition mode than for registering the dedicated service area.

Alternatively, the base station selection support system 10 may be configured to obtain service area information SAI that may comprise a representation of the second sets SS of radio signal parameter values and transmit this to the user device UE1 in step S10. This enables user device UE1 to evaluate against the first set FS of radio signal parameter values to estimate its location as being inside or outside the dedicated service area. In this embodiment, the second sets SS of radio signal parameters may be processed with one or more mathematical operations to obtain the service area information SAI. The service area information may, for example, comprise values, boundary values, intervals, or any other representation suitable to define the dedicated service area and to estimate location of the user device vis-á-vis the dedicated service area.

It should be appreciated that, when the user device UE1 is the same device as the user device UE that conducted the measurements of the second sets SS for defining the dedicated service area, the base station selection support system is not required for executing the disclosed cell selection, provided that the user device UE1 is configured to obtain or derive the service area information from the collected second sets of radio signal parameter values. To that end, the user device UE1 in FIG. 5 may use the code C performed on an internal processor of the selection system of this user device UE1. The user device UE1 may, for example, contain the machine learning module itself and use the collected second sets SS as input or may perform mathematical operations on the second sets SS to obtain the service area information.

When the service area definition mode is terminated and the service area information (or the second sets SS) is obtained by the user device UE1 from the base station selection support system 10 or is obtained and/or derived internally in the user device UE1, user device UE1 in idle mode measures radio signal parameter values from the base stations BS1 and BSA-BSC as indicated in step S11 as a first set FS of radio signal parameter values. When the user device UE1 in idle mode estimates that it is located in the dedicated service area 2 based on evaluation of the first set FS of parameter values obtained in step S11 and the service area information in step S10, cell selection of the dedicated base station BS1 is maintained even when the radio signal parameter values x of the public network, i.e. base station BSA, BSB or BSC, for the user device UE1 in the first set FS indicate that a cell of the public network would be better based on these signal strengths as such. This evaluation may take place frequently, for example upon each new measurement of the radio signal parameter values of one or more first sets FS as shown in steps S12 and S13.

In one embodiment, UE1 may start performing analysis against the service area information SAI only when it receives a radio signal of at least one of BS1, BS2, or BS3. This avoids that UE1 has to perform SAI analysis when it is very unlikely that the UE is located in a dedicated service area. The user device UE1 may e.g. know which base station identifiers belong to a dedicated service area, or may recognize a dedicated service area through another way (e.g. because of a CAG).

At some point in time, the user device UE1 in idle mode may estimate location not to be inside of the dedicated service area 2. The user device UE1 may then perform an analysis of the signal strengths for each of the base stations according to the prior art within the first set FS and find that, for example, public base station BSB provides the best connection.

In summary, the base station selection support system 10 enables user device UE1 to estimate its location to be within or outside of a dedicated service area 2 based on second sets SS of radio signal parameter values x that may be used as a kind of coarse coordinate system for cell selection. When the UE1 estimates that it is located in the dedicated service area 2, cell selection of a base station BS1 of the dedicated network may be maintained even when the radio signal parameter values x of the public network, i.e. base stations BSA, BSB or BSC, for the user device UE1 indicate that a better cell would be available in the public network.

The user device UE, as depicted in FIG. 5, is particularly suitable for use with the base station selection support system 10. The user device UE is configured to be set to the service area definition mode for transmitting the second sets SS of radio signal parameter values to the base station selection support system 10. The user device UE may be configured to assume the service area definition mode in response to at least one of a service area definition mode instruction from the base station selection support system 10 (step S1 in FIG. 4) and a user input on the user device. The user may traverse a trajectory with a user device UE in service area definition mode in the wireless coverage area of the dedicated network to define, for example, the dedicated service area 2. During this operation, the user device UE may gather several second sets SS of radio signal parameter values, such as RSRP values, from both one or more dedicated base stations BS1 and from one or more public base stations BSA-BSC, and report these to the base station selection support system 10. The base station selection support system 10 may subsequently process these values for obtaining the service area information as described above. The base station selection support system 10 may distribute the service area information to multiple user devices UE1 that have access to the dedicated network.

FIG. 5 may also depict user device UE1, wherein memory M stores the service area information SAI obtained from the base station selection support system 10 or to store derived service area information derived from received second sets SS of radio signal parameter values obtained from this system in raw or process form.

The radio signal parameter values of the first and second sets FS, SS may comprise reference signal received power, RSRP, measurements. RSRP measurements (typically expressed in dBm) are frequently used in telecommunications for cell selection decisions and provide for a relatively simple implementation for the base station selection support system 10 and/or the user device UE1. It should be appreciated that other parameters may be used as an alternative or in addition, such as reference signal received quality, RSRQ, and/or reference signal signal-to-interference (RS-SINR), typically expressed in dB, to determine location of the user device, although some additional processing of these parameter values may be required.

Whereas FIG. 3 shows that the base station selection support system 10 is connected to the dedicated base station BS1, it may be that the base station selection support system 10 is part of at least one dedicated base station. The base station selection support system 10 may, for example, be implemented in one dedicated base station BS1 or be distributed over two or more dedicated base stations of the dedicated network or be implemented in another centralized system or even in the public network.

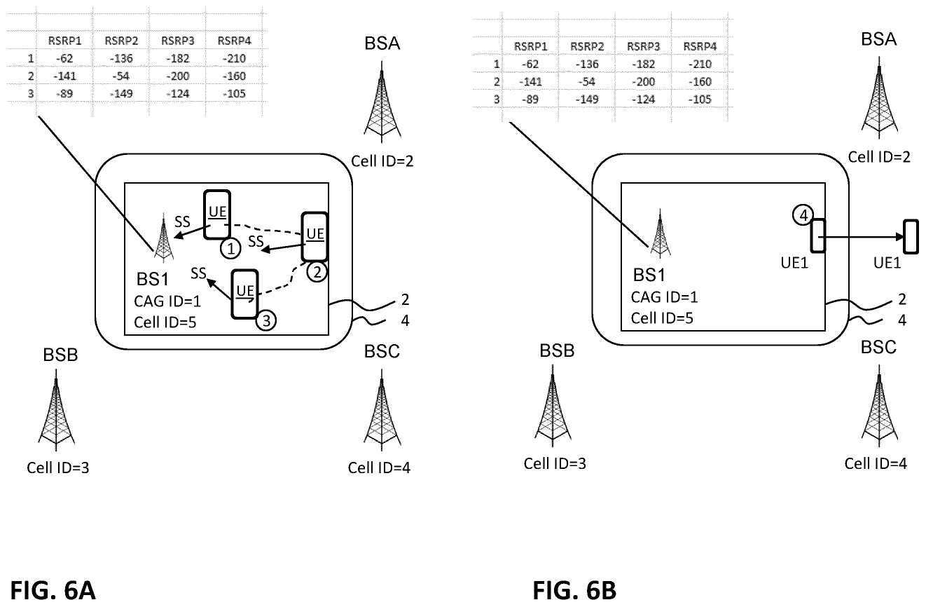

FIGS. 6A and 6B illustrate a practical example for use of the base station selection support system 10 in a home network and the user device UE for obtaining the service area information SAI.

The dedicated base station BS1 is configured to broadcast the Closed Access Group (CAG) ID which is provisioned in the UEs belonging to the home so other user devices do not attempt to access the home network and the home UEs can distinguish when the cell is part of the home network, for example in service area definition mode. It should be appreciated that other solutions to make user devices aware of differences between public base stations and dedicated base stations have been envisaged, including configuring cell IDs of the dedicated base stations in the base station selection support system or to store cell IDs of the dedicated base station in the user device UE.

The user device UE may measure an RSRP value RSRP1 related to the dedicated base station BS1. Simultaneously, the home location is also within coverage of a public network so that the user device UE will measure, for example RSRP2, RSRP3 and RSRP4 for base station BSA, BSB and BSC, respectively.

For the dedicated network, good radio planning is assumed, i.e., the dedicated base station BS1 is well placed such that it is able to offer optimal signal strength to the UEs within the entire physical area of the home 2.

During a service area definition mode, RSRP values of the base stations are recorded while the user device UE goes through the physical area of the home such that for several locations within the home, values of RSRP can be recorded. This can be done by means of the user walking around the house with the user device UE such that values can be recorded and stored. It should be appreciated that it is not needed that the location itself is recorded but only the radio signal parameter values are measured and assembled in sets {RSRP1, RSRP2, RSRP3, RSRP4} with values shown x5-x20 as shown in FIG. 3. These values may serve as a sort of a coordinate system, even though their values may not be decreasing linearly with the increase of distance due to the nature of wave propagation. It should be appreciated that it in some locations, it may not even be possible to measure a RSRP from one of the base stations. In this case, the measurement may be left blank, indicating no reception from that base station.

Once the RSRP values have been measured in service area definition mode and stored, and possibly processed, a value set may be created and boundary values for the four different RSRPs may be identified to represent the dedicated service area as service area information. Using a combination of these values may enable estimation in the user device UE1 whether the user device UE1 is within the dedicated service area or not (which corresponds to the rest of the values which are not in the table of FIGS. 6A, 6B). For example, if the values of the first set FS received by UE1 fall into the intervals designated as in-premises, user device UE1 will not select a public base station even if one or more public base stations BSA-BSC have better RSRP than the RSRP of a dedicated base station BS1 in a first set FS. Otherwise, UE1 will find itself to be outside the home area and UE1 will select a cell of the public base station as usual based on the signal strength (RSRP).

It should be appreciated that, while the example of FIGS. 6A and 6B employs four base stations which is appropriate for good three-dimensional space positioning, the disclosed user device UE, UE1 and system may be used with fewer base stations for reference. However, the more base stations can be measured by the UE, the more reference points for decision and the more accurate the decision may be especially with regards to the positioning within a 2D plane or 3D space. Furthermore, with the progress of advanced antenna systems and other similar solutions for base stations, it should be appreciated that the actual signal strength shows even more variation but if best values are taken (i.e. from the best possible beam of each base station) appropriate results may still be obtained.

As shown in FIGS. 6A and 6B, the base stations may broadcast their Cell IDs and the dedicated base station may also broadcast its CAG ID. A Closed Access Group identifies a group of subscribers who are permitted to access one or more CAG cells associated to the CAG. CAG is used to prevent UE(s), which are not allowed to access the associated cell(s), from automatically selecting and accessing the associated CAG cell(s). To use CAG, the UE, UE1, that supports CAG as indicated as part of the UE 5GMM Core Network Capability, may be pre-configured or (re)configured with the CAG information, included in the subscription as part of the Mobility Restrictions.

In operation, the user device UE in connected mode may connect to the dedicated base station BS1 and is configured by the dedicated base station BS1 to send measurement reports at a specific time interval or after a certain period of time or when the service area definition is completed. The UE and dedicated base station BS1 are put into service area definition mode, which is a calibration mode of the UE and dedicated base station BS1 in order to define the dedicated service area. The service area definition mode is executed by the user device UE sending one or more measurements for all the measurable base stations, optionally including their CAG IDs (if they belong to the same CAG as the currently serving dedicated base station BS1, otherwise the measurement is discarded since it belongs to another group/home). This mode can be either triggered by an action taken by the user of the UE (i.e. by activating a function in a menu on the device as shown in FIG. 5, in this case the user device UE may be in idle mode), or by the base station with a signal message (i.e. RRC reconfiguration message) as shown in FIG. 4, step S1.

To enable setting up a baseline for the measurements within the home area, the user of the user device UE moves through the home area that needs to be defined while the user device UE keeps performing measurements at, for example, regular intervals. The user may be informed that this activity needs to be undertaken to define the dedicated service area. The interval length of the measurements is either set by the dedicated base station in, for example, an RRC reconfiguration message, or configured by the user in the UE, depending on the trigger mentioned above. The measurements contain at least an indication of signal strength (in the form of RSRP or other indications like RSSI, SINR, etc.) and Cell ID for each of the four base stations (including CAG IDs, if applicable). The trajectory of the user device UE is depicted with a dashed line in FIG. 6A. In general, the user needs to allow the user device UE to perform measurements in relevant areas where he/she wants to define ‘the home area’ (or, more generally, the dedicated service area), especially along the borders between the home area 2 and possibly outside (e.g. in the attic, near windows, in the garden 4).

When the dedicated base station BS1 receives all these measurements of the second sets SS, the measurements are stored in, for example, a table as depicted in FIGS. 6A, 6B in a base station selection support system 10 (not shown individually in these figures). After traversing the premises is finished, indicated either by the user or automatically by the user device UE (i.e. by storing all the samples and analyzing that no new samples are present anymore) the user device UE may send a message to the dedicated base station BS1 that the data is collected (see also step S8 in FIG. 4) and the service area definition mode can be terminated.

After collecting all the data, the base station selection support system 10 at the dedicated base station BS1 processes the data and may, for example, determine value ranges by taking the minimum and maximum RSRP for each base station that fall in the home area as service area information. For the three sample table for locations 1, 2, 3 in FIG. 6A, these intervals are RSRP1=(−141, −62), RSRP2=(−149, −54), RSRP3=(−200, −124) and RSRP4=(−210, −105). This is a simple calculation and assumes a linear relationship between distance and signal strength which may be sufficient for certain arrangements. It should be appreciated that the accuracy requirement is not necessarily as stringent as with UE positioning. The simplicity is an advantage and may cater widespread use. If more stringent requirements are set, a more elaborate algorithm may be used or a machine learning model may be applied as described above.

Alternatively, this processing of the second sets SS is not done by the base station selection support system 10 but by the user device UE1.

In practical situations, complexities may arise from the actual physical environment, frequencies used and other variables. Another complexity is the advent of non-omnidirectional antenna solutions and beamforming. In order to gain accuracy and capture the actual relation, supervised Machine Learning algorithms for binary classification may be helpful. Binary classification refers to classification tasks that have two class labels and popular algorithms to do this are Logistic Regression, k-Nearest Neighbors, Decision Trees, Support Vector Machine, Naive Bayes and others. Two class labels appropriate for the disclosed solution are service area=Yes and service area=No. The training data for service area=Yes label has been already collected with the traversal of the user device UE across the service area as illustrated in FIG. 6A. Training data may also be needed for the label service area=No, for otherwise there may be not enough information for the algorithm to generate a boundary.

The latter training data can be generated in a second run following the first in-premises traversal with the user device UE being outside of the service area border. In this embodiment, the dedicated base station may send a message to the user device UE to start the ‘Premises Border Definition Mode’ (e.g. after step S8 in FIG. 4), which may pop up as a prompt to the user on the screen S of the user device UE and request for input when to start the data collection. After the user initiates this mode, the traversal of the user device UE outside of the dedicated service area starts and data is collected in the same manner as previously but this time with a different label-service area=No.

During this process, third sets of radio signal parameters are measured, but, since the coverage of the dedicated base station BS1 is optimized for the premises, the user device UE may lose connectivity in connected mode with the dedicated base station BS1 and may not be able to send regular or single RRC measurement reports. In this case, as well as in the case of the user device UE being in idle mode for some time, the user device UE may use memory M to store the radio signal parameter values and send them in a batch whenever connectivity is re-established by the lower layers with dedicated base station BS1. Alternatively, the UE in the premises border definition mode may be forced to communicate with dedicated base station BS1 only and may use memory M to store the third sets if communication with the dedicated base station BS1 is temporarily not possible.

When the process is complete, the dedicated base station BS1 may use the combined dataset with service area=Yes and service area=No labels to train a supervised ML algorithm which outputs a classifier for cell selection decisions.

When this measurement process is complete and dedicated service area information is available, the dedicated base station BS1 and the user device UE leave the service area definition mode and switch to normal operation by using these ranges in the cell selection decision. The user device UE1 performs regular measurements as usual. During this normal operation, the user device UE checks the measurements for the base stations BS1 and BSA-BSC as described above and checks whether the four values correspond with the calculated (or defined) premises values or intervals. If the outcome is positive, then the user device UE is still considered on-premises and maintains selection of the dedicated base station BS1.

For example, when a user device UE1 is in position 4 shown in FIG. 6B, the first set of RSRP values measured by the UE may indicate that public base station BSA offers a better connection than dedicated base station BS1. The first set FS may, for example, comprise {−130, −110, −170, −140}, all values are in the service area information interval, so that the user device UE1 is still considered on-premises. If UE1 moves out of the service area as shown in FIG. 6B, the first set FS of reported values will no longer fall within the intervals and the user device UE1 may select the cell of public base station BSA or BSC in the known manner.

Dedicated network(s) with a large service area and dedicated network(s) having higher frequency base stations may have deployed a plurality of dedicated base stations.

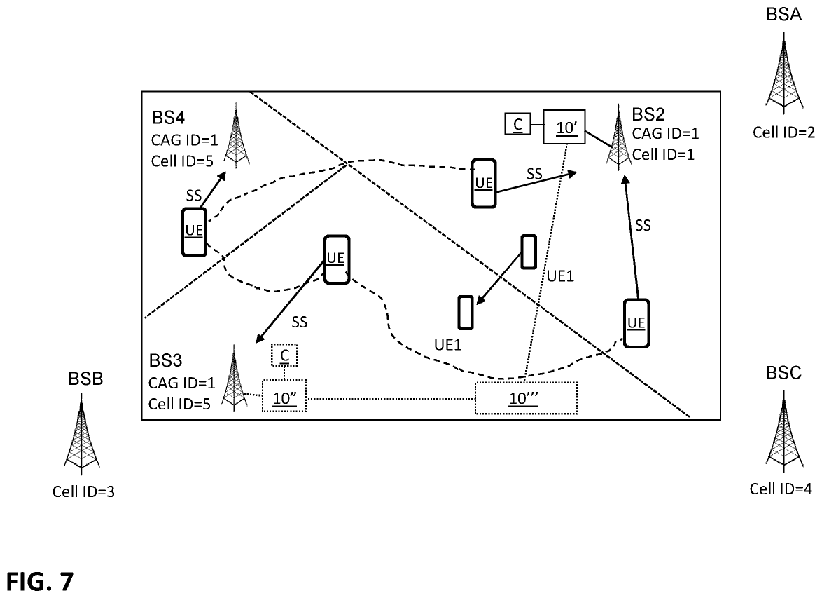

FIG. 7 is a schematic illustration of an embodiment of a base station selection support system for a dedicated network comprising a first dedicated base station BS2 and a second dedicated base station BS3. More dedicated base stations BS4, BS5 (not shown) etc., may be deployed for a dedicated network. The base station selection support system in FIG. 7 is distributed over subsystems 10′, 10″ and 10″′.

The user device UE1 comprises a selection system that may be configured to select a cell from the first dedicated base station BS2 or the second dedicated base station BS3 based on receiving a first radio signal parameter value for the first dedicated base station and a second radio signal parameter value for the second dedicated base station and comparing these values. This may occur when user device UE1 approaches base station BS3 as shown in FIG. 7. The embodiment allows cell reselection of dedicated base stations BS2, BS3 to be performed according to conventional cell reselection mechanisms, so that user devices UE1 camping on the dedicated network may be served by the dedicated base station with the best radio connection. A threshold may be applied to avoid frequent cell reselection between dedicated base stations when a user device UE1 measures approximately equal radio signal parameter values.

The service area definition mode may need to be adapted to the situation wherein multiple dedicated base stations are deployed when the service area definition mode is performed by an active user device UE.

The base station selection support system 10 may be configured to be set to service area definition mode to acquire the second sets SS of radio signal parameter values. The first dedicated base station BS2 may be configured to communicate setting to the service area definition mode to the second dedicated base station BS3. Such communication may be conducted over direct connections between the dedicated base stations BS2, BS3, via a gateway in the dedicated network or via the public network. The embodiment facilitates service area definition mode to be started for all dedicated base stations BS2, BS3 of the dedicated network. Such service area definition mode behavior comprises collecting and/or processing second (and possibly, third) sets of radio signal parameter values to define the dedicated service area, for example by training a machine learning model or to obtain a representation of such a dedicated service area.

In one example, all dedicated base stations BS2, BS3 of the dedicated network may be part of a closed access group (CAG) and broadcast a CAG ID to the user device UE, UE1 as shown in FIG. 7. All the user devices UE, UE1 within the service area may be configured with an ‘allowed CAG list’, such that the UE, UE1 can identify which dedicated base stations within the area are available for access. Along with the RSRP values recorded from all public and dedicated base stations, the user device UE may also report the associated CAG IDs to the serving dedicated base station in service area definition mode.

Moreover, the user device UE may be configured to receive and process one or more identifiers, such as the CAG ID or CAG IDs and/or the list of cell IDs of the dedicated base stations BS2, BS3, BS4. This information may be used to determine dedicated base stations during service area definition mode for which radio signal parameter values for the second sets are measured. The identifier or identifiers may be contained in a service area definition mode instruction SI in FIG. 4.

While conducting the measurements, when the active user device UE in service area definition mode is moving around within the intended service area, and moves away from dedicated base station BS2, RSRP1 will become weaker than the signal from another dedicated base station BS3 associated with value RSRP5. Before initiating handover to BS3, the dedicated network may check if the stronger signal for BS2 has an associated CAG ID. If yes, this means that the dedicated base station BS2 is associated with the same service area and handover may be initiated based on RSRP1 and RSRP5 (using a threshold for hysteresis, if applied). While initiating the handover, the serving dedicated base station BS2 may also send an indication to the new serving dedicated base station BS3 that the user device UE is in service area definition mode. The dedicated base stations BS2, BS3 may have Xn interfaces between each other so this would be an Xn handover in which case this indication may be sent over Xn. In the case of N2 handovers, however, the same indication can be transported over N2 via the AMF of the core network 1. This is also a valid procedure and also applies to a dedicated network with more than two dedicated base stations.

Likewise, when the user device UE is in idle mode, the user device may be configured to receive a first radio signal parameter value RSRP1 from dedicated base station BS1 and a second radio signal parameter value RSRP5 from dedicated base station BS3 to perform cell selection in the dedicated network based on comparing these values. Applying conventional cell reselection within the dedicated network (based e.g. on CAG ID or cell ID) is beneficial for an idle mode user device when it desires to connect to the dedicated network to report the second sets of radio signal parameter values to the base station selection support system.

The base station selection support system may store, use or distribute the second sets of radio signal parameter values in various ways.

For dedicated networks comprising more than one dedicated base station BS2, BS3, the first dedicated base station BS2 and the second dedicated base station BS3 may be configured to store the second sets SS of radio signal parameter values received from the first user device UE1 or another user device UE at least during service area definition mode using selection support subsystems 10′ and 10″. Since a user device UE reports the second sets SS of radio signal parameter values to the serving dedicated base station, both the first dedicated base station and the second dedicated base station may receive second sets SS of radio signal parameter values. To define the dedicated service area, it is advantageous that the dedicated base stations BS2, BS3 of the dedicated network store these values to allow defining the dedicated service area when the user device has finished the service area definition mode.

Furthermore, the first dedicated base station BS2 and the second dedicated base station BS3 may exchange second sets SS of radio signal parameter values with each other. The embodiment enables each dedicated base station BS2, BS3 to obtain all the second sets of radio signal parameter values for the dedicated base stations of the dedicated network, so that each individual base station BS2, BS3 can obtain the service area information for the full service area and provide this to a user device, if necessary. Base station BS3 is provided with a local support subsystem 10″ as part of the base station selection support system.

The first dedicated base station BS2 and the second dedicated base station BS3 may also send the second sets SS of radio signal parameter values to a central base station support system 10″′ or to the user device UE. This facilitates centralization of the service area information for centralized deriving of the service area information or enables distribution of the second sets of radio signal parameter values by the user device UE. For example, for dedicated base station BS4 not having a base station selection support system, user device UE may store the second sets and make them available to base station support system 10″′, for example. Also, as mentioned above, user device UE may obtain or derive its own service area information for its own cell selection routine.

Alternatively, the first dedicated base station BS2 may be configured to obtain service area information representative of a dedicated service area of the first dedicated base station of the dedicated network on the basis of the received second sets SS of radio signal parameter values. Likewise, the second dedicated base station BS3 may be configured to obtain service area information representative of a dedicated service area of the second dedicated base station of the dedicated network on the basis of the received second sets SS of radio signal parameter values. This embodiment facilitates obtaining partial service area information that can be communicated to a user device for cell selection. The user device UE may be configured to integrate the several parts to full service area information for the dedicated service area. The benefit of this is that no centralized base station support system is required and, base stations don't need to be aware of each other.

In FIG. 7, dedicated base stations BS2, BS3 may be aware of each other's existence in the dedicated network. Hence, when the service area definition mode is terminated, a termination signal or indication may be sent or forwarded to all dedicated base stations BS2, BS3. For example, when user device UE sends a termination signal to dedicated base station BS2, subsystem 10′ may send this signal to subsystem 10″ of dedicated base station BS3 and/or any other system of a dedicated base station of the dedicated network to signal that service area information can be derived from the measurements and made available to user devices in the dedicated network for cell reselection as described above.

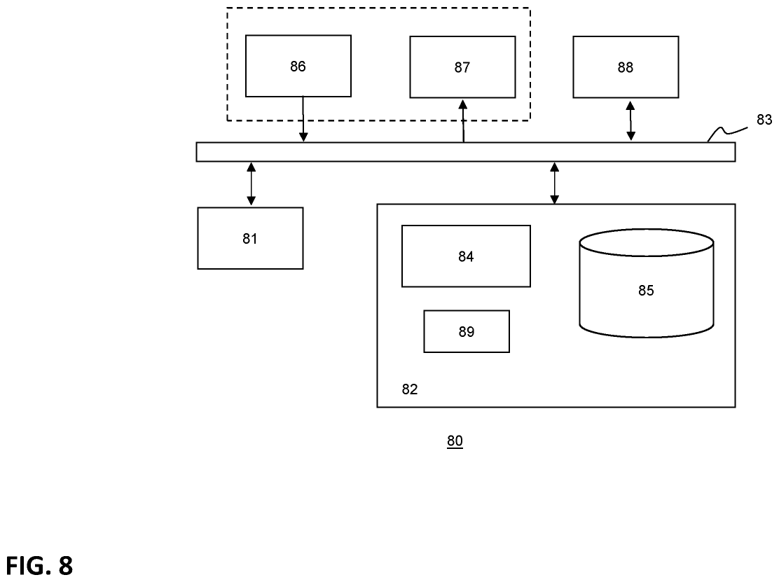

FIG. 8 depicts a block diagram illustrating an exemplary processing system according to a disclosed embodiment, e.g. a base station selection support system 10 or a user device for use with such a base station selection support system as disclosed herein. As shown in FIG. 8, the processing system 80 may include at least one processor 81 coupled to memory elements 82 through a system bus 83. As such, the processing system may store program code within memory elements 82. Further, the processor 81 may execute the program code accessed from the memory elements 82 via a system bus 83. In one aspect, the processing system may be implemented as a computer system that is suitable for storing and/or executing program code. It should be appreciated, however, that the processing system 80 may be implemented in the form of any system including a processor and a memory that is capable of performing the functions described within this specification.

The memory elements 82 may include one or more physical memory devices such as, for example, local memory 84 and one or more bulk storage devices 85. The local memory may refer to random access memory or other non-persistent memory device(s) generally used during actual execution of the program code. A bulk storage device may be implemented as a hard drive or other persistent data storage device. The processing system 80 may also include one or more cache memories (not shown) that provide temporary storage of at least some program code in order to reduce the number of times program code must be retrieved from the bulk storage device 85 during execution.

Input/output (I/O) devices depicted as an input device 86 and an output device 87 optionally can be coupled to the processing system. Examples of input devices may include, but are not limited to, a space access keyboard, a pointing device such as a mouse, or the like. Examples of output devices may include, but are not limited to, a monitor or a display, speakers, or the like. Input and/or output devices may be coupled to the processing system either directly or through intervening I/O controllers.

In an embodiment, the input and the output devices may be implemented as a combined input/output device (illustrated in FIG. 8 with a dashed line surrounding the input device 86 and the output device 87). An example of such a combined device is a touch sensitive display, also sometimes referred to as a “touch screen display” or simply “touch screen” that may be provided with the UE. In such an embodiment, input to the device may be provided by a movement of a physical object, such as e.g. a stylus or a finger of a person, on or near the touch screen display.

A network adapter 88 may also be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system 80, and a data transmitter for transmitting data from the processing system 80 to said systems, devices and/or networks. Modems, cable modems, and Ethernet cards are examples of different types of network adapter that may be used with the processing system 80.

As pictured in FIG. 8, the memory elements 82 may store an application 89. In various embodiments, the application 89 may be stored in the local memory 84, the one or more bulk storage devices 85, or apart from the local memory and the bulk storage devices. It should be appreciated that the processing system 80 may further execute an operating system (not shown in FIG. 8) that can facilitate execution of the application 89. The application 89, being implemented in the form of executable program code, can be executed by the processing system 80, e.g., by the processor 81. Responsive to executing the application, the processing system 80 may be configured to perform one or more operations or method steps described herein.

In one aspect of the present invention, one or more components of the base station selection support system and/or user device for use with such a base station selection support system. as disclosed herein may represent processing system 80 as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 81 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration but is not intended to be exhaustive or limited to the implementations in the form disclosed. Many modifications and variations will be apparent to those of ordinary skill in the art without departing from the scope of the claims. The embodiments were chosen and described in order to best explain the principles and some practical applications of the present invention, and to enable others of ordinary skill in the art to understand the present invention for various embodiments with various modifications as are suited to the particular use contemplated.

1. A user device configured to select at least one dedicated base station of a dedicated network or at least one public base station of a public network, wherein a wireless coverage area of the dedicated network overlaps at least in part with a wireless coverage area the public network, wherein the user device comprises:
a receiving system configured to receive a first set of radio signal parameter values for the at least one dedicated base station and the at least one public base station;
a selection system configured to select the at least one public base station only when the first set of radio signal parameter values indicates location of the user device outside a dedicated service area of the dedicated network based on service area information,
wherein the user device further comprises the service area information representative of the dedicated service area of the dedicated network defined on the basis of a plurality of second sets of radio signal parameter values of the at least one dedicated base station and the at least one public base station.

2. The user device according to claim 1, wherein the user device is configured to at least one of:
obtain the plurality of second sets of radio signal parameter values of the at least one dedicated base station and the at least one public base station to derive the service area information in the user device;
transmit the second sets of radio signal parameter values of the at least one dedicated base station and the at least one public base station to a base station selection support system of the dedicated network; and
receive the service area information from a base station selection support system of the dedicated network.

3. The user device according to claim 1, wherein the service area information comprises:
a machine learning model, wherein the model is trained using at least the second sets of radio signal parameter values, wherein the machine learning model is configured to input a first set of radio signal parameter values acquired by a user device to the trained machine learning model and the output indicates whether the user device is located outside the dedicated service area, and wherein, optionally, the output of the machine learning model is a binary output indicating location of the user device inside or outside of the dedicated service area and the model is trained in addition using at least a third set of radio signal parameter values of the at least one dedicated base station and the at least one public base station outside of the dedicated service area;
or
a representation of the second sets of radio signal parameter values enabling evaluation of the first set of radio signal parameter values to estimate whether the user device is located outside the dedicated service area.

4. The user device according to claim 1, wherein the user device is configured to be set to a service area definition mode in response to at least one of:
a service area definition mode instruction from a base station selection support system, wherein the instruction, optionally, provides a report time interval to report second sets of radio signal parameter values to the base station selection support system, and
a user input on the user device.

5. The user device according to claim 1, wherein the user device is configured to at least one of:
transmit at least one identifier of at least one dedicated base station, such as a closed access group identifier, CAG ID, or a group of cell IDs, to a base station selection support system;
receive and process at least one identifier of at least one dedicated base station to determine dedicated base stations during service area definition mode for which radio signal parameter values for the second sets are measured, wherein optionally, the identifier is contained in a service area definition mode instruction,
and wherein, optionally, the user device is configured to obtain service area information representative of a dedicated service area of at least a first dedicated base station and a second dedicated base station.

6. The user device according to claim 1, wherein the user device is configured to receive the service area information via at least one signaling message, wherein, optionally, the signaling message is at least one of:
a radio resource control, RRC, message for connection establishment;
an RRC message for connection release;
a Non-Access Stratum, NAS, message for connection establishment;
a NAS message for connection release;
a policy message from a Policy Control function.

7. The user device according to claim 1, wherein the user device is configured to receive a first radio signal parameter value for a first dedicated base station and a second radio signal parameter value for a second dedicated base station to perform cell selection in the dedicated network based on comparing these values.

8. A base station selection support system configured to support selection of at least one dedicated base station of a dedicated network or at least one public base station of a public network, wherein a wireless coverage area of the dedicated network overlaps at least in part with a wireless coverage area of the public network, wherein the base station selection support system comprises:
service area information representative of the dedicated service area of the dedicated network defined on the basis of a plurality of second sets of radio signal parameter values of the at least one dedicated base station and the at least one public base station; and
a transmission system for transmitting the service area information to a user device for selection of a dedicated base station on the basis of the transmitted service area information.

9. The base station selection support system according to claim 8, wherein the service area information comprises:
a machine learning model, wherein the model is trained using at least the second sets of radio signal parameter values, wherein the machine learning model is configured to input a first set of radio signal parameter values acquired by a user device to the trained machine learning model and the output indicates whether the user device is located outside the dedicated service area, and wherein, optionally, the output of the machine learning model is a binary output indicating location of the user device inside or outside of the dedicated service area and the model is trained in addition using at least a third set of radio signal parameter values of the at least one dedicated base station and the at least one public base station outside of the dedicated service area;
or
a representation of the second sets of radio signal parameter values enabling evaluation of the first set of radio signal parameter values to estimate whether the user device is located outside the dedicated service area.

10. The base station selection support system according to claim 8, wherein the base station selection support system is configured to acquire the second sets of radio signal parameter values for defining the dedicated service area from a user device or another user device,
wherein, optionally, the base station selection support system is configured to send a service area definition mode instruction to at least one of the user device and the other user device to acquire the second sets of radio signal parameter values for defining the dedicated service area, and
wherein, optionally, the service area definition mode instruction provides a report time interval for the user device or the other user device to report the second sets of radio signal parameter values.

11. The base station selection support system according to claim 8, wherein the base station selection support system is configured to transmit the service area information to the user device using a signaling message, comprising, optionally, at least one of:
a radio resource control, RRC, message for connection establishment;
an RRC message for connection release;
a Non-Access Stratum, NAS, message for connection establishment;
a NAS message for connection release;
a policy message from a Policy Control function.

12. The base station selection support system according to claim 8, wherein the dedicated network comprises at least a first dedicated base station and a second dedicated base station, wherein the base station selection support system is configured to initiate handover of the first user device from the first dedicated base station to the second dedicated base station based on receiving a first radio signal parameter value for the first dedicated base station and a second radio signal parameter value for the second dedicated base station and comparing these values.

13. The base station selection support system according to claim 8, wherein at least a part of the base station selection support system is configured to be set to a service area definition mode to acquire the second sets of radio signal parameter values by at least one of:
receiving a service area definition mode instruction from a user device; and
communicating setting the service area definition mode from the first dedicated base station to the second dedicated base station.

14. The base station selection support system according to claim 8, wherein the dedicated network comprises at least a first dedicated base station and a second dedicated base station, comprising at least one of the following:
the first dedicated base station and the second dedicated base station being configured to store the second sets of radio signal parameter values received from the first user device or another user device at least during service area definition mode;
the first dedicated base station and the second dedicated base station exchanging second sets of radio signal parameter values with each other;
the first dedicated base station and the second dedicated base station sending the second sets of radio signal parameter values to a central location or to the user device or other user device;
the first dedicated base station obtaining service area information representative of a dedicated service area of the first dedicated base station of the dedicated network on the basis of the received second sets of radio signal parameter values and the second base station obtaining service area information representative of a dedicated service area of the second dedicated base station of the dedicated network on the basis of the received second sets of radio signal parameter values,
and wherein the base station selection support system is configured to send at least one of the second sets of radio signal parameters and the service area information to the user device.

15. The base station selection support system according to claim 8, wherein the base station selection support system is configured to terminate the service area definition mode by at least one of the following:
receiving a service area definition mode termination instruction from a user device
expiry of a definition mode timer and/or by an analysis of the second sets of radio signal parameter values;
communicating the termination of the service area definition mode from a dedicated base station to one or more other dedicated base stations of the dedicated network;
storing information from which dedicated base station a user device entered a cell of a dedicated base station in service area definition mode and forwarding a service area definition mode termination indication in accordance with the stored information.

16. The base station selection support system according to claim 8, wherein the system is part of at least one dedicated base station.

17. The user device according to claim 1, wherein the radio signal parameter values of the first and second sets comprise reference signal received power, RSRP, measurements.

18. The base station selection support system according to claim 8, wherein the radio signal parameter values of the first and second sets comprise reference signal received power, RSRP, measurements.
